(19) United States
(12) Patent Application Publication
(10) Pub. No.: US 2008/0037761 A1
(43) Pub. Date: Feb. 14, 2008

(54) Remotely Monitoring Call Center Statistics

(75) Inventors: Jeffrey William Cordell, Omaha, NE (US); Jereomy K. Frum, Omaha, NE (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(73) Assignee: West Corporation, Omaha, NE (US)

(21) Appl. No.: 11/427,013

(22) Filed: Jun. 28, 2006

(51) Int. Cl. H04M 3/00

(52) U.S. Cl. 379/265.04

(57) ABSTRACT

A system, method, and computer readable medium for remotely monitoring call center statistics, that comprises, monitoring virtual automated call distribution connection status of an agent, scanning agent desktop environment connection status of the agent, surveying server logon status of the agent, auditing computer schedule status of the agent, observing network throughput status of the agent, scoring the call center statistics based upon the monitored virtual automated call distribution connection status, the scanned agent desktop environment connection status, the surveyed server logon status, the audited computer schedule status and the observed network throughput status, and displaying the scored call center statistics by agent.

### CROSS REFERENCE TO RELATED APPLICATIONS

The present patent application is related to commonly assigned U.S. Patent Application Docket No. PAT-072 entitled SESSION INITIATION PROTOCOL ENABLED AGENT DESKTOP ENVIRONMENT, and U.S. Patent Application Docket No. PAT-074 entitled SCRIPT LOGIC GRAPHICAL MAPPING, and U.S. Patent Application Docket No. PAT-075 entitled SCRIPT LOGIC VIEWING, and U.S. Patent Application Docket No. PAT-076 entitled REAL TIME FEEDBACK OF SCRIPT LOGIC, and U.S. Patent Application Docket No. PAT-077 entitled CONTACT CENTER CALL ROUTING BY AGENT ATTRIBUTE filed on even date herewith, the entire contents of which are incorporated by reference herein.

### BACKGROUND OF THE INVENTION

A contact center is a group trained agents or technicians that are required to use a telephone and computer to perform their duties. Integration of voice (telephone) and data (PC) create an agents ‘desktop environment’.

A trend in contact center technology is the growing use of ‘virtual’ contact centers. This is based on the principle of employing contact center agents, employees and/or contractors, for the completion of contact center duties from their home or other remote location in essence working in general local office suites also referred to as hotel workers. Virtual contact center agents require reliable network interconnectivity to include a Public Switched Telephone Network (PSTN) and Internet Protocol (IP) networks. The contact center provider must provide or publish the services and tools to perform: agent authentication, encryption for secure data during transport, and relevant 3^{rd} party application interfaces to complete the contact center agent duties. Clients employ contact center providers to perform their customer contact duties. Customers are those individuals that use some form of communication, telephone, email, instant message and fax.

To increase call center customer satisfaction, agents must have accurate timely information and must respond quickly. This timely and accurate response by the agent is enabled by multiple systems interacting simultaneously. To increase flexibility and reduce costs many agents prefer to work from home, this is referred to as a Work At Home Agent (WAHA). The management of these work at home agent requires an overview system that quickly allows management to determine resource issues for the agent, such as system loading or disconnections, or if the agent is not answering their phone in a timely manner. Therefore a need exists for call center management to be able to quickly discern call center issues and identify the root cause of those issues.

### SUMMARY OF THE INVENTION

The present invention which is a call center statistical monitor (named Mood Viewer) that provides real time monitoring statistics pertaining to customers from the Agent Desktop Environment (ADE) without adding overhead to the call taking process.

Each agent desktop environment session has the capability of logging vital events to a Structured Query Language (SQL) database (tblLogs). The SQL database logs hold data regarding events that occur during an agent's login session and are much like an audit trail. These events include communication between the agent and the system architecture.

The agent desktop environment call center statistical monitor application is for real time monitor agent activity on the agent desktop environment. It will report back agent desktop environment agents on Brick and Mortar (BM) as well as Work At Home Agent (WAHA) platforms.

The call center statistical monitor application is also expandable with other components via Simple Object Access Protocol (SOAP) interface messages. It currently accesses the Virtual Automated Call Distribution (VACD) to get queue information and it can access specialized scripts to get agent information via simple object access protocol.

The web site has several reports which are useful in tracking agents, adding new reports to the platform is simple and the web service interface allows for data integration from other sources for reporting purposes. A virtual help desk attendant (named Agent Jean) can monitor the system and send notifications if a set of requirements have been met.

The call center statistical monitor can assist in expansive projects that require data from the agent logs. One scenario might entail having a script log a simple string each time a panel is loaded. If the scripts standard panel is modified to log this information, the feature could then be toggled on and off at a script level.

When the log monitor process finds this string it can enhance call center statistical monitor by providing up to date information on what panel each agent is using at the current time. Furthermore, the agent desktop environment logs web Service can provide panel statistics on what panels are causing issues among agents etc. It could also provide back information to developers to indicate what panel was last loaded prior to agents logging an exception.

The agent desktop environment call center statistical monitor website reads the summarized statistics, the monitor provides, from the database and formats it into several reports. These reports may be useful to several levels of management interested in seeing real time statistics from the agent desktop environment platform or WAHA platform.

The call center statistical monitor website creates a user session which allows some customization such as how far to “scan back” in time, how often to refresh the statistics and it even allows you to scope some reports down to a specific list of agents.

Call center statistical monitor reports may include:

By project, by status overview—Shows each active project and a summary of each phone status with the number of agents in each status.

By project overview—Shows every agent in a specified project

By Agent Mood—Agents can be assigned “moods” based on events found in the logs (such as exceptions or high latency counts).

Status History Reporting—Shows recent history by status (how many agents were on a call, how many were not, how many were in queue etc).

Disconnect Report—Shows how many agents experienced a Citrix Disconnect.

Citrix Latency Charts—Graphs each Citrix Server a specified agent is connected to and the latency times.

Inbound to Calls logged Report—Shows agents that have discrepancies between calls delivered and calls logged.

Citrix Latency Summary—Shows each Citrix server, what agents are connected to it and what each agent's latency time is.

The agent desktop environment call center statistical monitor incorporates a process (named Nasher) that reads each agents log file. It is coded to search out the agent's identification, the current phone status, Citrix identification, project identification, and any exceptions logged. It also uses a configuration file to determine additional values to seek out and stores them into a generalized table in the database.

The configuration file also allows the monitor service to store multiple agent desktop environment production databases to monitor. The data from each of the production database's is then stored into a centralized and summarized database. The monitor can search for specified values from the logs and/or count the number of times an event happens (count inbound calls for instance).

The monitor also incorporates one minute, five minute and 30 minute events to allow for automatic data clean up and summarization. It also sends a query (via SOAP) to the VACD to gather agent queue information.

The agent desktop environment logs web service allows any other system component to use a standard SOAP message and post statistics back to the agent desktop environment logs database. This might include posting agent statistics directly from WIC or the VACD. The web Service can also be modified to allow agent queries from call center statistical monitor too.

The virtual help desk attendant (Agent Jean) monitors the system and notifies subscribed personnel of an event. The event might be that a certain number of system exceptions have occurred in a given amount of time or the ratio of agents signed on to agents on a call has dropped past a certain level. The virtual help desk agent uses project history to show trend analysis. He can also run reports and mail them out to account managers.

Due to the fact that every customer or every project is different, the virtual help desk agent allows each subscriber to specify what is acceptable and what is not. Each subscriber can also specify time frames when the virtual help desk attendant should be checking on a given project and how often to notify when something is wrong. Notifications can be sent via e-mail or e-mail pager.

The Citrix ICA session monitor posts latency information directly to the agent desktop environment 50 logs database from the Citrix Servers. The information is further summarized to show averages per agent per server for trend analysis. The Citrix ICA session monitor posts information every 5 minutes.

The agent desktop environment monitor process can attach to each of the production databases and collect the necessary data by simply supplying it a valid connection string.

Currently the call center statistical monitor system requires no changes to the existing agent desktop environment database design to function. A planned enhancement is to add stored procedures necessary to query the agent desktop environment logs table for the purpose of further enhancing the query time against the table. The call center statistical monitor system requires read only access to the agent desktop environment database.

The agent desktop environment logs database is the summarized repository for both the monitor and the Citrix ICA session monitor. The database has the following tables:

The LOGS table contains an entry for every agent's agent desktop environment Session.

LOGS Design

[LOG_ENV] [varchar] (5)—Represents the Production agent desktop environment 50 SQL Server the agents log resides on.

[LOG_IDent] [varchar] (50)—A unique identifier in the form of a GUID to identify an agents session.

[LOG_Date] [datetime]—The date and time the agents session began.

[LOG_AgentID] [varchar] (10)—The agents Tandem logon ID.

[LOG_CitrixID] [varchar] (50)—The agents Citrix User ID

[LOG_status] [varchar] (25)—The last/current phone status for the agent.

[LOG_Score] [numeric](18, 0)—A score assigned to the current session based on events found in the log.

[LOG_projectID] [varchar] (50)—The project ID the agent is calling on.

[LOG_LastUpdate] [datetime]—The last time this row was updated by the log Monitor or web Service.

Data in this table is purged after 7 days automatically by the monitor Service. This figure is adjustable from the monitor Configuration file. Logs are kept for 7 days to allow the agent Lookup Screen (from the web service) to retrieve logs. The number of rows in the table depends entirely on how many agent desktop environment agents sign in during a given week and how many agents have multiple session per day. The expected database size is around 30,000 rows and subject to grow as more clients are brought online.

The LOGS_NAMEVALUE table is a generalized table which stores configurable values based on the configuration file of the monitor Service.

LOGS_NAMEVALUE Design

[NV_Env] [varchar] (5) Represents the Production agent desktop environment 50 SQL Server the agents log resides on.

[NV_IDent] [varchar] (50) A unique identifier in the form of a GUID to identify an agents session.

[NV_Name] [varchar] (50) The name or description of the item captured from the logs.

[NV_Value] [varchar] (150) If a value is sought, it is stored in this field.

[NV_Count] [numeric](18, 0) If a count is sought, the current count (number of times value was found in logs).

[NV_LastUpdate] [datetime] The last time this row was updated by the LOG_monitor or web Service.

Data in this table is purged after 7 days automatically by the monitor Service. This figure is adjustable from the monitor Configuration file. Logs are kept for 7 days to allow the agent Lookup Screen (from the web service) to retrieve logs. The number of rows in the table depends entirely on how many agent desktop environment agents sign in during a given week multiplied by the number of items sought in the monitor configuration file. The expected database size is around 350,000 rows and subject to grow as more clients are brought online.

The MARKER table stores the last know record read from each of the production agent desktop environment Servers from the tblLogs table. It is updated by the monitor service and in the event of a service restart; the monitor will use it to pick up where it left off.

MARKER Design

[Mark_ProgramID] [char] (10)—A unique identifier to identify the production server.

[Mark_DateTime] [datetime]—The last date and time this row was updated.

[Mark_Marker] [int]—The last primary key read from the tblLogs table in the Production Environment.

There is no retention plan necessary for this table. Each row is updated every 5 seconds by the monitor service. The number of rows depends entirely on how many agent desktop environment production servers are running. The current expected row count is 3.

The GeneralTrends table stores information captured by the virtual help desk attendant in a generalized format. This is trending information that is used by the agent desktop environment logs web interface.

GeneralTrends Table Design

[GT_Time] [datetime]—The Date and Time the row was inserted.

[GT_Type] [varchar] (50)—The type or description of the statistic being stored.

[GT_Item] [varchar] (50)—An optional identifier to further describe the type being stored.

[GT_Desc] [varchar] (50)—An additional identifier to further describe the type being stored.

[GT_Value] [numeric](18, 0)—The value for the 3 formally described identifiers.

Data in this table is automatically purged after 7 days by the monitor service. The number of rows depends entirely on how many statistics the virtual help desk attendant is set to save but is expected to grow from 135,000 rows.

The CitrixApplications table stores each application that is stored on each of the various Citrix Servers.

CitrixApplications Table Design

[ID] [int] IDENTITY (1, 1)—A unique identifier for each row inserted.

[UpdateTime] [datetime]—The last date and time the row was updated.

[Application] [char] (200)—The name of the application on the Citrix Server.

[ServerName] [char] (20)—The Citrix Server Name the application is stored on.

[Farm] [char] (10)—The identifier for the Citrix Farm the Citrix Server belongs to.

Data is this table is automatically purged by a DTS package as updated data is being placed into the table. The number of rows in this table will grow from 1,000 based on the number of applications multiplied by the number of Citrix Servers.

The CitrixLatencySummary Table stores summarized data from the CitrixUserLatency Table.

CitrixLatencySummary Table Design

[CL_UserName] [varchar] (50)—The Citrix USER ID of the data being stored.

[CL_Date] [smalldatetime]—The small date of the date the row was inserted.

[CL_ServerName] [varchar] (16)—The name of the Citrix Server the agent was using.

[CL_LastUpdate] [datetime]—The last time a ping was received for the user, on the server on the date specified.

[CL_AVGLatency] [int]—The Average latency from the user on the server on the Date specified.

[CL_CURLatency] [int]—The latest latency from the user on the server on the Date specified.

[CL_LOLatency] [int]—The lowest latency count from the user on the server on the date specified.

[CL_HILatency] [int]—The highest latency count from the user on the server on the date specified.

[CL_Cnt] [int]—The number of pings received for the user on the server on the date specified.

[CL_Diff] [int]—The difference between the current ping and previous ping.

[CL_AVGDiff] [int]—The difference between the current average and the previous average.

Data in this table is automatically purged after 7 days by the monitor Service. The number of rows is based on how many unique Citrix Users are signed on multiplied by the number of distinct server names a given user logs into. The expected row count is around 30,000 rows.

The CitrixServers table contains a row for each Citrix Server and what client group runs on each server.

CitrixServers Table Design

[id] [int] IDENTITY (1, 1)—A unique key associated to each server name.

[ServerName] [char] (20)—The Citrix Server Name identified.

[ServerGroup] [char] (50)—The Group or Client name associated to the Server.

[Farm] [char] (10)—The name of the Citrix Farm the server is associated to.

Data in this table is automatically removed by a DTS package as updated data is being inserted. The number of rows is dependent on the number of Citrix Servers defined and as expected to be around 100 rows.

The CitrixUserLatency table stores information about each PING from a given Citrix Server and Citrix User.

CitrixUserLatency Table Design

[id] [int] IDENTITY (1, 1)—A unique identifier assigned to each row.

[UpdateTime] [datetime]—The date and time from the Citrix ICA Session Monitor.

[SessionName] [char] (50)—Identifies the Citrix Session ID for the User on the Server.

[Username] [char] (50)—The Citrix User ID on the Server.

[ServerName] [char] (16)—The Server name the Citrix User is attached to.

[AveICALatency] [int]—The users average latency per Server.

[LastRecICALatency] [int]—The users last latency count per server.

[LastUpdateDate] [datetime]—The date and time the row was inserted.

Data is this table is removed after 24 hours by the monitor Service. The expected row count varies based on the number of users logged into a Citrix Server multiplied by the number of Citrix Servers they log into in a 24 hour period. This count is expected to grow from 120,000.

The RTAgentInfoSG stores information concerning what applications a given agent has started during their Citrix Session.

RTAgentInfoSG Design

[ConnectTime] [datetime]—The date and time the Citrix Agent started the application

[Username] [char] (50)—The Citrix User ID

[ClientIP] [char] (20)—The I.P. Address of the Client.

[ApplicationName] [char] (50)—The name of the application started by the Citrix ID.

[webSiteName] [char] (20)—The URL of the Gateway used by the Citrix ID.

[SGName] [char] (20)—The name of the secured gateway used by the Citrix ID.

Data in the RTAgentInfoServer table is automatically deleted after 7 days by the monitor Service. The expected row count depends on number of Citrix agents signing in multiplied by the number of applications each agent starts. The row count should increase from 4,000.

In one embodiment of the present invention, a method for remotely monitoring call center statistics, that comprises monitoring virtual automated call distribution connection status of an agent, scanning agent desktop environment connection status of an agent, surveying server logon status of an agent, auditing computer schedule status of an agent, observing network throughput status of an agent, scoring the call center statistics based upon the monitored virtual automated call distribution connection status, the scanned agent desktop environment connection status, the surveyed server logon status, the audited computer schedule status and the observed network throughput status, and displaying the scored call center statistics by agent. The method may also comprise detecting virtual automated call distribution error status of an agent, determining the server error status of an agent, analyzing network latency of an agent, wherein the display of the scored call center statistics by agent is color coded, calculating agent status statistics by agent, feeding back calculated agent status statistics to the agent, accessing individual occurrences of the monitored virtual automated call distribution connection status, the scanned agent desktop environment connection status, the surveyed server logon status, the audited computer schedule status and the observed network throughput status, separating the scoring the call center statistics by agent, providing detailed scoring the call center statistics by agent to assess quality control issues.

In a further embodiment of the present invention, a computer readable medium comprising instructions for, monitoring virtual automated call distribution connection status of an agent, scanning agent desktop environment connection status of an agent, surveying server logon status of an agent, auditing computer schedule status of an agent, and observing network throughput status of an agent. The computer readable medium may comprise instructions for detecting virtual automated call distribution error status of an agent, determining server error status of an agent, analyzing network latency of an agent, scoring call center statistics based upon the monitored virtual automated call distribution connection status, the scanned agent desktop environment connection status, the surveyed server logon status, the audited computer schedule status, the observed network throughput status, the detected virtual automated call distribution error status, the determined server error status and the analyzed network latency of the agent and displaying the scored call center statistics by agent.

In yet a further embodiment, a system for remotely monitoring call center statistics, that comprises, a processor in communication with a memory which is monitoring at least one agent, wherein the processor monitors virtual automated call distribution connection status of an agent, scans agent desktop environment connection status of an agent, surveys server logon status of an agent, audits computer schedule status of an agent and observes network throughput status of an agent, and a memory communicably coupled to the processor, wherein the memory stores the monitoring from the at least one agent. Wherein the processor calculates agent status statistics by agent and feeds back calculated agent status statistics to the agent, scores the call center statistics based upon the monitored virtual automated call distribution connection status, the scanned agent desktop environment connection status, the surveyed server logon status, the audited computer schedule status and the observed network throughput status and accesses individual occurrences of the monitored virtual automated call distribution connection status, the scanned agent desktop environment connection status, the surveyed server logon status, the audited computer schedule status and the observed network throughput status.

### BRIEF DESCRIPTION OF THE DRAWINGS

FIG. 1 depicts a first system of call center statistical monitoring in accordance with a preferred embodiment of the present invention;

FIG. 2 depicts a second system of call center statistical monitoring in accordance with a preferred embodiment of the present invention;

FIG. 3 depicts a first score of call center statistical monitoring in accordance with a preferred embodiment of the present invention;

FIG. 4 depicts a second score of call center statistical monitoring in accordance with a preferred embodiment of the present invention;

FIG. 5 depicts a third score of call center statistical monitoring in accordance with a preferred embodiment of the present invention;

FIG. 6 depicts a fourth score of call center statistical monitoring in accordance with a preferred embodiment of the present invention;

FIG. 7 depicts a fifth score of call center statistical monitoring in accordance with a preferred embodiment of the present invention;

FIG. 8 depicts a sixth score of call center statistical monitoring in accordance with a preferred embodiment of the present invention;

FIG. 9 depicts a first method of call center statistical monitoring in accordance with a preferred embodiment of the present invention;

FIG. 10 depicts a second method of call center statistical monitoring in accordance with a preferred embodiment of the present invention;

FIG. 11 depicts a first software flow block of call center statistical monitoring in accordance with a preferred embodiment of the present invention;

FIG. 12 depicts a second software flow block of call center statistical monitoring in accordance with a preferred embodiment of the present invention;

FIG. 13 depicts a third system of call center statistical monitoring in accordance with a preferred embodiment of the present invention; and

FIG. 14 depicts a fourth system of call center statistical monitoring in accordance with a preferred embodiment of the present invention.

### DETAILED DESCRIPTION OF THE INVENTION

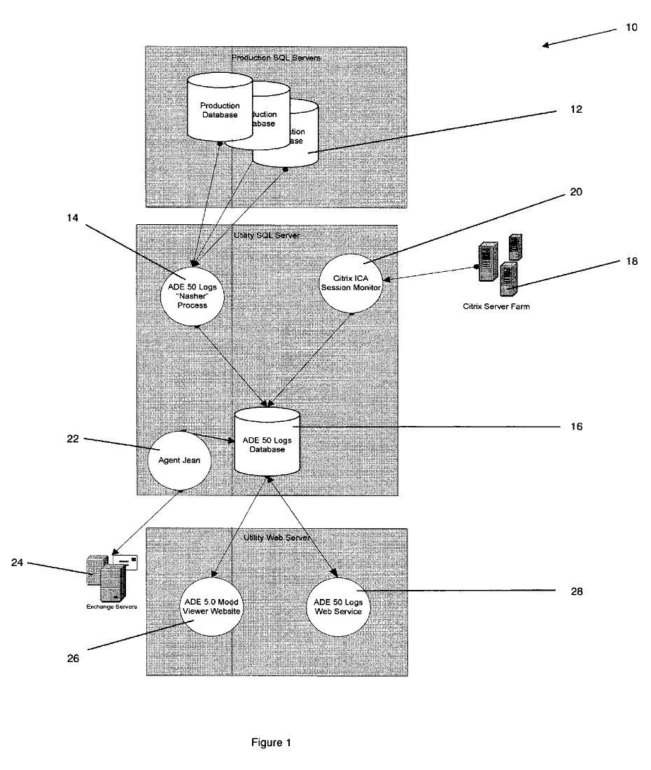

Referring now to FIG. 1, a system 10 of remotely monitoring call center statistics is depicted. The production SQL servers form a database 12 that is in communication with an agent desktop environment 14 which is in communication with an agent desktop environment log database 16. A Citrix server 18 is in communication with a session monitor 20 which in turn is in communication with the agent desktop environment log database. A virtual help desk attendant (Agent Jean) 22 monitors the agent desktop environment log database. The virtual help desk attendant is in communication with an exchange server 24. The utility web server is made up of agent desktop environment mood viewer 26 and agent desktop environment logs 28 both in communication with the agent desktop environment logs database. These blocks or modules are software, hardware, firmware, and/or the combination of software, hardware, and/or firmware.

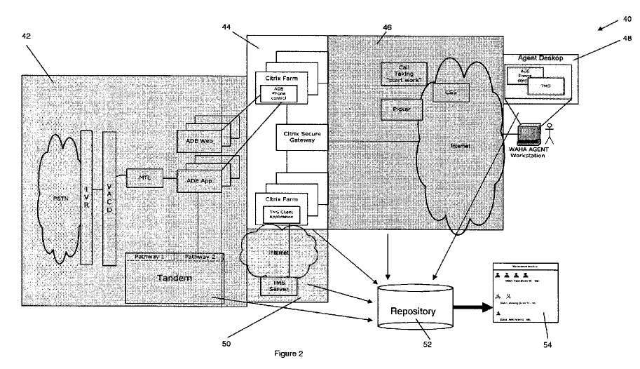

Referring now to FIG. 2, a second system of call center statistical monitoring 40 is depicted and comprises a number of blocks or modules that are software, hardware, firmware, and/or the combination of software, hardware, and/or firmware. The system is comprised of a virtual automated call distribution block 42 which is in communication with a Citrix server farm block 44. The internet protocol inter-network block 46 is in communication with the Citrix server farm and is in communication with the work at home agent block 48. The server which provides the agent desktop environment block 50 is in communication with the Citrix server farm. Each of the VACD block, ADE block, Citrix server block, WAHA block and IP inter-network blocks are in communication with a repository 52 which gives an agent status output 54. For example, the repository may be accessed by the cellular phone or the computer with external wireless capability (such as the wireless card) or internal wireless capability (such as 802.11 or any of the other 802 variants), or by the Internet Protocol enabled phone. The communications occurs via at least one of the wireless protocol, the wired protocol and the combination of the wireless protocol and the wired protocol.

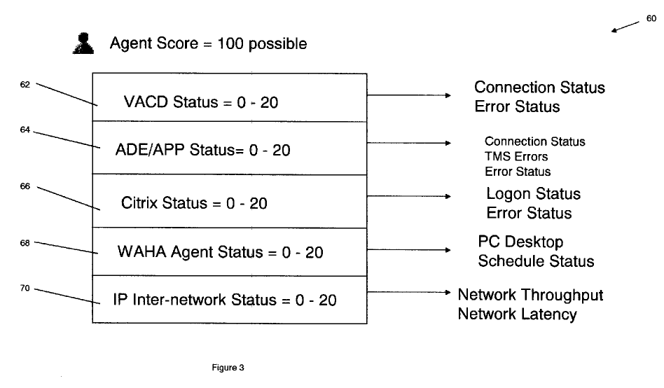

Referring now to FIG. 3, a first score of call center statistical monitoring 60 is depicted and comprises a number of blocks or modules that are software, hardware, firmware, and/or the combination of software, hardware, and/or firmware. The VACD status 62 gives the connection and error status of the virtual automated call distribution block shown in FIG. 2. The ADE status 64 gives the connection, error and TMS error status of the automated desktop environment block shown in FIG. 2. The Citrix server status 66 gives the logon and error status of the Citrix server farm block shown in FIG. 2. The work at home agent status 68 shows the PC desktop schedule status of the work at home agent block shown in FIG. 2. The IP inter-network status 70 shows the network throughput and latency of the internet protocol inter-network block shown in FIG. 2. Each of the status is scored between 0 and 20 to give a total score of 0 to 100.

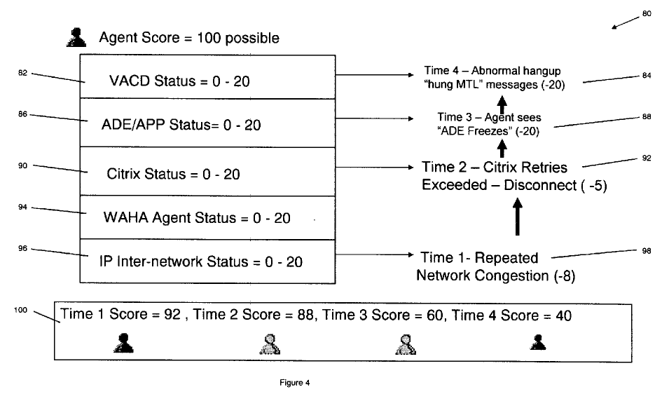

Referring now to FIG. 4, a second score of call center statistical monitoring 80 is depicted and comprises a number of blocks or modules that are software, hardware, firmware, and/or the combination of software, hardware, and/or firmware. The VACD status 82 gives the connection and error status of the virtual automated call distribution block shown in FIG. 2. In this example there was an abnormal hung MTL error message 84. The ADE status 86 gives the connection, error and TMS error status of the automated desktop environment block shown in FIG. 2. In this example the error agent sees ADE freezes 88 is shown. The Citrix server status 90 gives the logon and error status of the Citrix server farm block shown in FIG. 2. In this example the error Citrix retries exceeded and disconnected 92 is shown. The work at home agent status 94 shows the PC desktop schedule status of the work at home agent block shown in FIG. 2. The IP inter-network status 96 shows the network throughput and latency of the internet protocol inter-network block shown in FIG. 2. In this example the error of repeated network congestion 98 is shown. Each of the status is scored 100 between 0 and 20 to give a total score of 0 to 100.

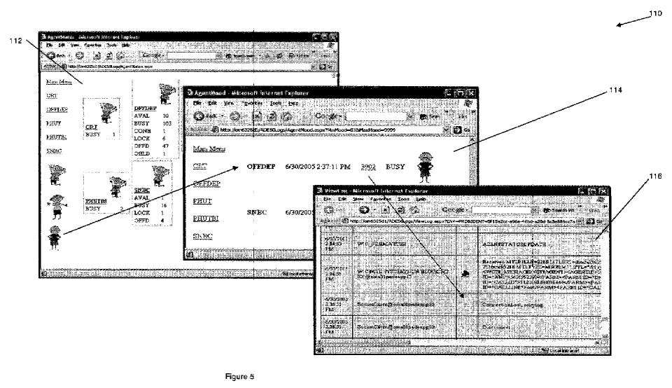

Referring now to FIG. 5, a third score of call center statistical monitoring 110 in accordance with a preferred embodiment of the present invention is depicted. The overall visual display 112 allows more detailed viewing of a specific agent 114 and the actual logged errors 116 to help resolve any systemic issues. The transfer of information between the repository and the monitor occurs via at least one of a wireless protocol, a wired protocol and the combination of the wireless protocol and the wired protocol. The steps performed in this figure are performed by software, hardware, firmware, and/or the combination of software, hardware, and/or firmware.

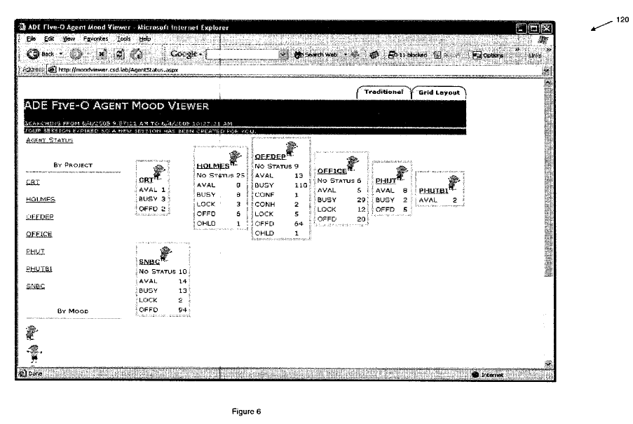

Referring now to FIG. 6, a fourth score of call center statistical monitoring 120 in accordance with a preferred embodiment of the present invention is depicted. The view seen is the overall visual display which gives an over view of the agent interaction with the system.

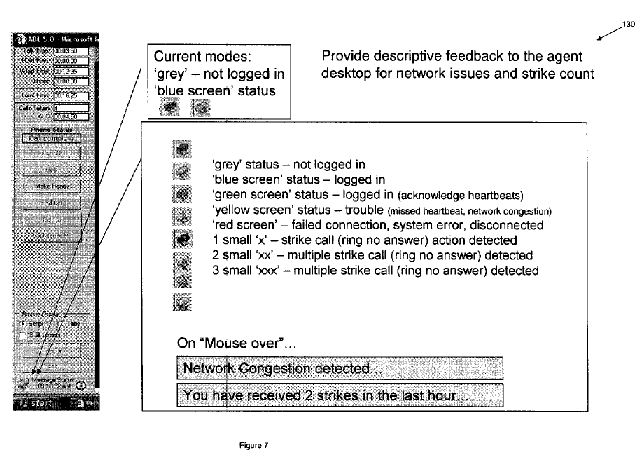

Referring now to FIG. 7, a fifth score of call center statistical monitoring 130 in accordance with a preferred embodiment of the present invention is depicted. This is the screen that the work at home agent sees, which gives a feedback overview of the operating efficiency of the agent. The transfer of information between the repository and the monitor occurs via at least one of a wireless protocol, a wired protocol and the combination of the wireless protocol and the wired protocol. The steps performed in this figure are performed by software, hardware, firmware, and/or the combination of software, hardware, and/or firmware.

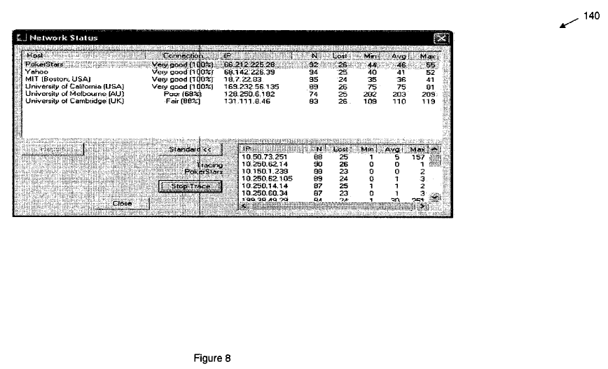

Referring now to FIG. 8, a sixth score of call center statistical monitoring 140 in accordance with a preferred embodiment of the present invention is depicted. In this example the connection status of the network is shown from node to node. This method is preferably embodied in a computer readable medium or software but may also be embodied in firmware and is utilized via hardware. The transfer of information between the repository and the monitor occurs via at least one of a wireless protocol, a wired protocol and the combination of the wireless protocol and the wired protocol. The steps performed in this figure are performed by software, hardware, firmware, and/or the combination of software, hardware, and/or firmware.

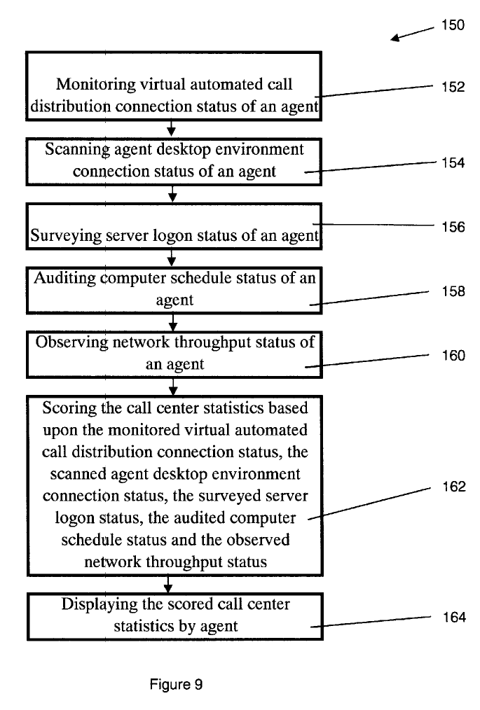

Referring now to FIG. 9, a first method of call center statistical monitoring 150 is depicted. A method for remotely monitoring call center statistics, that comprises monitoring 152 virtual automated call distribution connection status of an agent, scanning 154 agent desktop environment connection status of the agent, surveying 156 server logon status of the agent, auditing 158 computer schedule status of the agent, observing 160 network throughput status of the agent, scoring 162 the call center statistics based upon the monitored virtual automated call distribution connection status, the scanned agent desktop environment connection status, the surveyed server logon status, the audited computer schedule status and the observed network throughput status, and displaying 164 the scored call center statistics by agent. The method is performed by software, hardware, firmware, and/or the combination of software, hardware, and/or firmware.

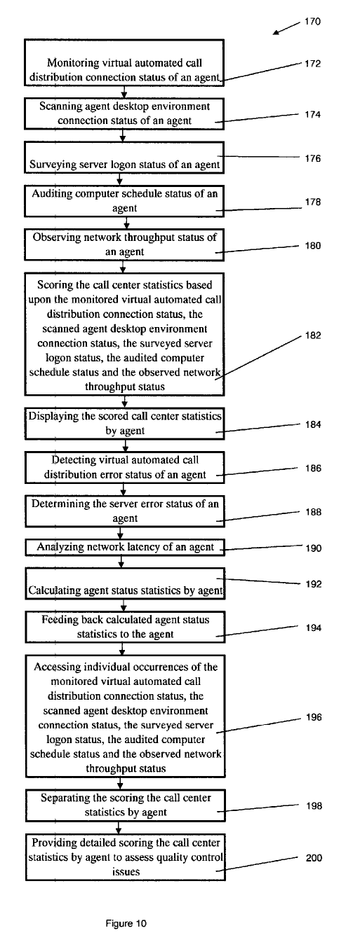

Referring now to FIG. 10, a second method of call center statistical monitoring 170 is depicted. A method for remotely monitoring call center statistics, that comprises monitoring 172 virtual automated call distribution connection status of an agent, scanning 174 agent desktop environment connection status of the agent, surveying 176 server logon status of the agent, auditing 178 computer schedule status of the agent, observing 180 network throughput status of the agent, scoring 182 the call center statistics based upon the monitored virtual automated call distribution connection status, the scanned agent desktop environment connection status, the surveyed server logon status, the audited computer schedule status and the observed network throughput status, and displaying 184 the scored call center statistics by agent. The method may also comprise detecting 186 virtual automated call distribution error status of an agent, determining 188 the server error status of an agent, analyzing 190 network latency of an agent, wherein the display of the scored call center statistics by agent is color coded, calculating 192 agent status statistics by agent, feeding 194 back calculated agent status statistics to the agent, accessing 196 individual occurrences of the monitored virtual automated call distribution connection status, the scanned agent desktop environment connection status, the surveyed server logon status, the audited computer schedule status and the observed network throughput status, separating 198 the scoring the call center statistics by agent, providing 200 detailed scoring the call center statistics by agent to assess quality control issues. The method is performed by software, hardware, firmware, and/or the combination of software, hardware, and/or firmware.

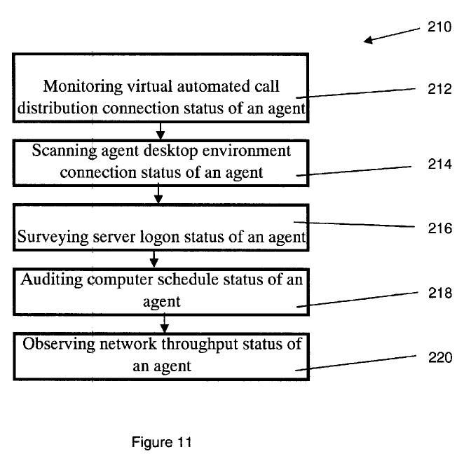

Referring now to FIG. 11, a first software flow block of call center statistical monitoring 210 is depicted. A computer readable medium comprising instructions for, monitoring 212 virtual automated call distribution connection status of an agent, scanning 214 agent desktop environment connection status of an agent, surveying 216 server logon status of an agent, auditing 218 computer schedule status of an agent, and observing 220 network throughput status of an agent. This method is preferably embodied in a computer readable medium or software but may also be embodied in firmware and is utilized via hardware. The transfer of information between the repository and the monitor occurs via at least one of a wireless protocol, a wired protocol and the combination of the wireless protocol and the wired protocol. The steps performed in this figure are performed by software, hardware, firmware, and/or the combination of software, hardware, and/or firmware.

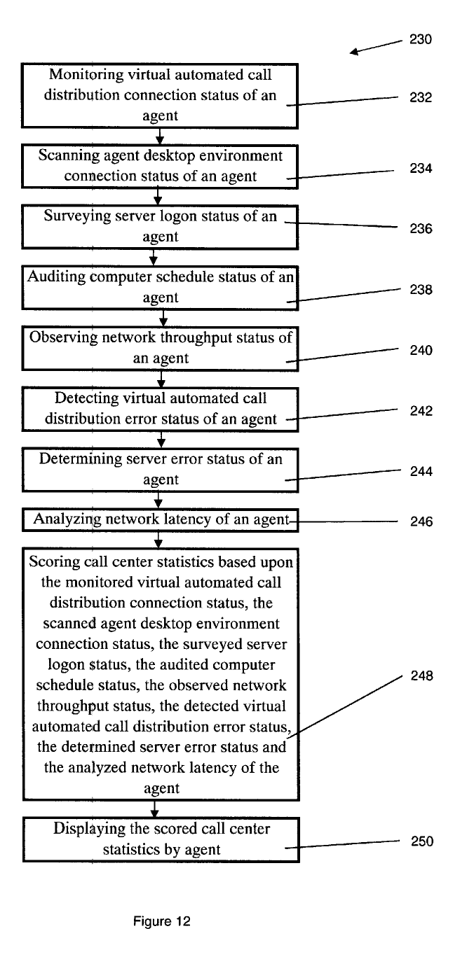

Referring now to FIG. 12, a second software flow block of call center statistical monitoring 230 is depicted. A computer readable medium comprising instructions for, monitoring 232 virtual automated call distribution connection status of an agent, scanning 234 agent desktop environment connection status of an agent, surveying 236 server logon status of an agent, auditing 238 computer schedule status of an agent, and observing 240 network throughput status of an agent. The computer readable medium may comprise instructions for detecting 242 virtual automated call distribution error status of an agent, determining 244 server error status of an agent, analyzing 246 network latency of an agent, scoring 248 call center statistics based upon the monitored virtual automated call distribution connection status, the scanned agent desktop environment connection status, the surveyed server logon status, the audited computer schedule status, the observed network throughput status, the detected virtual automated call distribution error status, the determined server error status and the analyzed network latency of the agent and displaying 250 the scored call center statistics by agent. This method is preferably embodied in a computer readable medium or software but may also be embodied in firmware and is utilized via hardware. The transfer of information between the repository and the monitor occurs via at least one of a wireless protocol, a wired protocol and the combination of the wireless protocol and the wired protocol. The steps performed in this figure are performed by software, hardware, firmware, and/or the combination of software, hardware, and/or firmware.

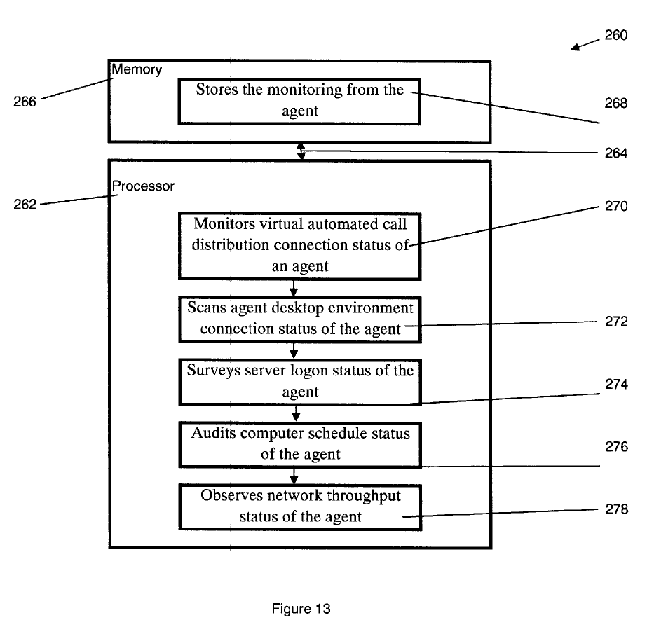

Referring now to FIG. 13, a third system of call center statistical monitoring 260 is depicted. A system for remotely monitoring call center statistics, that comprises, a processor 262 in communication 264 with a memory 266 which is monitoring at least one agent 268, wherein the processor monitors 270 virtual automated call distribution connection status of an agent, scans 272 agent desktop environment connection status of an agent, surveys 274 server logon status of an agent, audits 276 computer schedule status of an agent and observes 278 network throughput status of an agent, and a memory communicably coupled to the processor, wherein the memory stores the monitoring from the at least one agent. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

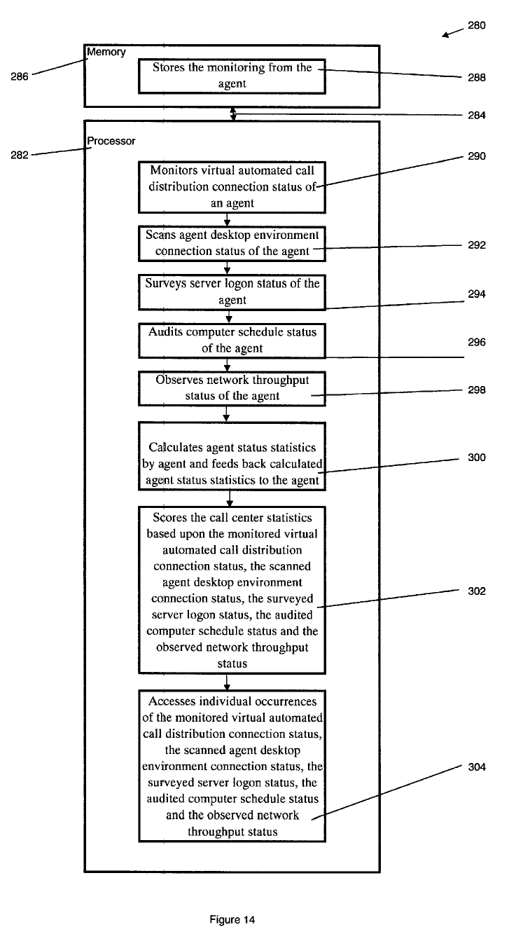

Referring now to FIG. 14, a fourth system of call center statistical monitoring 280 is depicted. A system for remotely monitoring call center statistics, that comprises, a processor 282 in communication 284 with a memory 286 which is monitoring 288 at least one agent, wherein the processor monitors 290 virtual automated call distribution connection status of an agent, scans 292 agent desktop environment connection status of an agent, surveys 294 server logon status of an agent, audits 296 computer schedule status of an agent and observes 298 network throughput status of an agent, and a memory communicably coupled to the processor, wherein the memory stores the monitoring from the at least one agent. Wherein the processor calculates 300 agent status statistics by agent and feeds back calculated agent status statistics to the agent, scores 302 the call center statistics based upon the monitored virtual automated call distribution connection status, the scanned agent desktop environment connection status, the surveyed server logon status, the audited computer schedule status and the observed network throughput status and accesses 304 individual occurrences of the monitored virtual automated call distribution connection status, the scanned agent desktop environment connection status, the surveyed server logon status, the audited computer schedule status and the observed network throughput status. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the virtual automated call distribution systems, agent desktop environments, Citrix servers, work at home agent systems, internet protocol inter-network connections, or via software and devices utilized by mobile agents. Also, these capabilities may be performed in the current manner or in a distributed manner and on, or via, any device able to provide and/or receive broadband signals. Further, although depicted in a particular manner, various modules or blocks may be repositioned without departing from the scope of the current invention. For example, the functionality performed by the repository can be self-contained. Still further, although depicted in a particular manner, a greater or lesser number virtual automated call distribution systems, agent desktop environments, Citrix servers, work at home agent systems and internet protocol inter-network connections can be utilized with the present invention in order to accomplish the present invention, to provide additional known features to the present invention, and/or to make the present invention more efficient.

What is claimed is:

1. A method for remotely monitoring call center statistics, comprising:
monitoring virtual automated call distribution connection status of an agent;
scanning an agent desktop environment connection status of the agent;
surveying a server logon status of the agent;
auditing a computer schedule status of the agent;
observing a network throughput status of the agent;
scoring the call center statistics based upon the monitored virtual automated call distribution connection status, the scanned agent desktop environment connection status, the surveyed server logon status, the audited computer schedule status and the observed network throughput status; and
displaying the scored call center statistics.

2. The method of claim 1 comprising:
detecting a virtual automated call distribution error status of the agent.

3. The method of claim 1 comprising:
determining the server error status of the agent.

4. The method of claim 1 comprising:
analyzing a network latency of the agent.

5. The method of claim 1 wherein the display of the scored call center statistics by the agent is color coded.

6. The method of claim 1 comprising:
calculating agent status statistics by the agent.

7. The method of claim 6 comprising:
feeding back calculated agent status statistics to the agent.

8. The method of claim 1 comprising:
accessing individual occurrences of the monitored virtual automated call distribution connection status, the scanned agent desktop environment connection status, the surveyed server logon status, the audited computer schedule status and the observed network throughput status.

9. The method of claim 1 comprising:
separating the scoring of the call center statistics by the agent.

10. The method of claim 1 comprising:
providing detailed scoring of the call center statistics by the agent to assess quality control issues.

11. A computer readable medium comprising instructions for:
monitoring a virtual automated call distribution connection status of an agent;
scanning an agent desktop environment connection status of the agent;
surveying a server logon status of the agent;
auditing a computer schedule status of the agent; and
observing a network throughput status of the agent, in order to remotely monitor call center statistics.

12. The computer readable medium of claim 11 comprising instructions for detecting a virtual automated call distribution error status of the agent.

13. The computer readable medium of claim 12 comprising instructions for determining a server error status of the agent.

14. The computer readable medium of claim 13 comprising instructions for analyzing a network latency of the agent.

15. The computer readable medium of claim 14 comprising instructions for
scoring call center statistics based upon the monitored virtual automated call distribution connection status, the scanned agent desktop environment connection status, the surveyed server logon status, the audited computer schedule status, the observed network throughput status, the detected virtual automated call distribution error status, the determined server error status and the analyzed network latency of the agent.

16. The computer readable medium of claim 15 comprising instructions for
displaying the scored call center statistics by the agent.

17. A system for remotely monitoring call center statistics, comprising:
a processor that monitors virtual automated call distribution connection status of an agent, scans agent desktop environment connection status of the agent, surveys server logon status of the agent, audits computer schedule status of the agent and observes network throughput status of the agent; and
a memory communicably coupled to the processor, wherein the memory stores functionality performed by the agent.

18. The system of claim 17 wherein,
the processor calculates agent status statistics of the agent and provides the calculated agent status statistics to the agent.

19. The system of claim 17 wherein,
the processor scores the call center statistics based upon the monitored virtual automated call distribution connection status, the scanned agent desktop environment connection status, the surveyed server logon status, the audited computer schedule status and the observed network throughput status.

20. The system of claim 17 wherein,
the processor accesses individual occurrences of the monitored virtual automated call distribution connection status, the scanned agent desktop environment connection status, the surveyed server logon status, the audited computer schedule status and the observed network throughput status.
